(19) United States
(12) Patent Application Publication
(10) Pub. No.: US 2023/0366247 A1
(43) Pub. Date: Nov. 16, 2023

(54) VEHICLE DOOR LOCK APPARATUS

(71) Applicant: AISIN CORPORATION, Kariya (JP)

(72) Inventor: Naoto NONOMURA, Kariya-shi (JP)

(73) Assignee: AISIN CORPORATION, Kariya (JP)

(21) Appl. No.: 18/314,225

(22) Filed: May 9, 2023

(30) Foreign Application Priority Data
May 13, 2022 (JP) 2022-079282

(51) Int. Cl. E05B 85/26; E05B 81/68

(52) U.S. Cl. CPC E05B 85/26; E05B 81/68; E05B 85/243

(57) ABSTRACT

A vehicle door lock apparatus includes: a latch mechanism; a casing including two guide surfaces facing each other; a first member supported to be rotatably movable between a first position and a second position with respect to the casing; a second member supported to be movable with respect to the casing and elastically biased toward a third position, the second member being configured to move the first member; a key switch; and a third member whose one end portion is rotatably coupled to the second member and whose other end portion is provided with a sliding portion between the two guide surfaces, the third member being configured to switch ON and OFF of the key switch by moving with respect to the casing in conjunction with movement of the second member. The sliding portion of the third member has a substantially circular shape.

### CROSS REFERENCE TO RELATED APPLICATIONS

This application is based on and claims priority under 35 U.S.C. §119 to Japanese Patent Application 2022-079282, filed on May 13, 2022, the entire content of which is incorporated herein by reference.

### TECHNICAL FIELD

This disclosure relates to a vehicle door lock apparatus.

### BACKGROUND DISCUSSION

In related art, there is known a vehicle door lock apparatus configured to be switched between a locked state and an unlocked state by an operation of a key cylinder. For example, JP 2012-41764A (Reference 1) discloses a vehicle door lock apparatus including a lever member (referred to as an “internal key lever” in Reference 1) that rotationally moves in conjunction with an operation of a key cylinder, and a lock lever and an open link that are movable between a lock position and an unlock position in conjunction with rotational movement of the lever member. The lock lever and the open link are brought into an unlocked state when located at the unlock position and into a locked state when located at the lock position.

Further, the vehicle door lock apparatus disclosed in Reference 1 is capable of detecting a switching operation between the locked state and the unlocked state performed by a user. Specifically, the door lock apparatus disclosed in Reference 1 includes a detection member (referred to as a “detected link” in Reference 1) that moves in an upper-lower direction in conjunction with the movement of the lever member, and a switch (referred to as a “detection switch” in Reference 1) that is configured to switch between ON and OFF according to the movement of the detection member. The movement of the lever member (that is, the switching operation between the locked state and the unlocked state performed by the user) is detected by detecting the switching between ON and OFF of the switch.

Specifically, the detection member of the vehicle door lock apparatus disclosed in Reference 1 has a long rod shape elongated in the upper-lower direction. An upper end portion of the detection member is fitted into a groove that is provided in a casing and extends in the upper-lower direction. Accordingly, the detection member is guided to be movable in the upper-lower direction with respect to the casing. On the other hand, a long hole that is elongated in a vehicle front-rear direction is provided in a lower end portion of the detection member, and a protrusion portion provided on the lever member is inserted into the long hole. Accordingly, when the lever member rotates, the detection member moves in the upper-lower direction, and the switch is switched between ON and OFF by the movement of the detection member in the upper-lower direction.

In the configuration disclosed in Reference 1, the detection member may swing in a pendulum manner around the upper end portion thereof. When the detection member swings in this manner, a contact state between the upper end portion of the detection member and an inner peripheral surface of the guide groove provided in the casing changes (a relative angle between the upper end portion of the detection member and the inner peripheral surface of the guide groove changes). As a result, smooth upper-lower movement of the detection member may be hindered. In addition, when the detection member swings as described above, the protrusion portion of the lever member may collide with an inner peripheral surface of the long hole of the detection member and generate a contact sound (a striking sound). Such a contact sound may be perceived as an abnormal sound by the user.

A need thus exists for a vehicle door lock apparatus which is not susceptible to the drawback mentioned above.

### SUMMARY

According to an aspect of this disclosure, a door lock apparatus includes:
a latch mechanism configured to be switched between a latched state in which opening of a vehicle door provided on a vehicle is not allowed and an unlatched state in which opening of the vehicle door is allowed;
a casing including two guide surfaces facing each other, the two guide surfaces extending in a first direction and being spaced apart from each other in a second direction perpendicular to the first direction;
a first member supported to be rotatably movable between a first position and a second position with respect to the casing, the first member being configured to restrict switching of the latch mechanism from the latched state to the unlatched state when the first member is located at the first position, and being configured to allow switching of the latch mechanism from the latched state to the unlatched state when the first member is located at the second position;
a second member supported to be movable with respect to the casing and elastically biased toward a third position, the second member being configured to move the first member located at the second position to the first position when the second member is moved from the third position to a fourth position by a manual operation, and being configured to move the first member located at the first position to the second position when the second member is moved from the third position to a fifth position by a manual operation;
a key switch that is an electrical switch configured to detect that the second member is manually operated, the key switch being switchable between an ON state and an OFF state; and
a third member whose one end portion is rotatably coupled to the second member and whose other end portion is provided with a sliding portion that is movably guided in the first direction with respect to the casing by being inserted between the two guide surfaces in a manner of being movable in the first direction, the third member being configured to switch ON and OFF of the key switch by moving with respect to the casing in conjunction with movement of the second member from the third position to the fourth position and movement of the second member from the third position to the fifth position, and
the sliding portion of the third member has a substantially circular shape when viewed in a third direction perpendicular to the first direction and the second direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a schematic view showing a configuration of a vehicle door;

FIG. 1B is a schematic view showing a configuration of the vehicle door;

FIG. 2 is a perspective view showing a configuration of a vehicle door lock apparatus;

FIG. 3 is an exploded perspective view showing the configuration of the vehicle door lock apparatus;

FIG. 4 is a perspective view showing members disposed inside a casing of an actuator body;

FIG. 5A is a view showing a configuration and operations of an external key lever, an internal key lever, an active lever, an active lever link, a key switch link, and a key switch;

FIG. 5B is a view showing the configuration and the operations of the external key lever, the internal key lever, the active lever, the active lever link, the key switch link, and the key switch;

FIG. 6A is a view showing the configuration and the operations of the external key lever, the internal key lever, the active lever, the active lever link, the key switch link, and the key switch;

FIG. 6B is a view showing the configuration and the operations of the external key lever, the internal key lever, the active lever, the active lever link, the key switch link, and the key switch;

FIG. 7A is a perspective view showing a configuration of the key switch link;

FIG. 7B is a perspective view showing a configuration of the key switch link, a guide portion, the key switch, and a support board;

FIG. 7C is a perspective view showing operations of the key switch link and the key switch; and

FIG. 7D is a perspective view showing the operations of the key switch link and the key switch.

### DETAILED DESCRIPTION

Hereinafter, an embodiment disclosed here will be described with reference to the drawings. In the following description, each direction of a vehicle door lock apparatus is based on each direction of a vehicle (vehicle body). In each drawing, a front side of the vehicle is indicated by an arrow Fr, a rear side of the vehicle is indicated by an arrow Rr, an upper side of the vehicle is indicated by an arrow Up, a lower side of the vehicle is indicated by an arrow Dw, an outer side in a vehicle width direction (left-right direction) of the vehicle is indicated by an arrow Out, and an inner side in the vehicle width direction of the vehicle is indicated by an arrow In. An upper-lower direction is an example of a first direction disclosed here, a front-rear direction is an example of a second direction disclosed here, and the vehicle width direction is an example of a third direction disclosed here.

### Vehicle Door

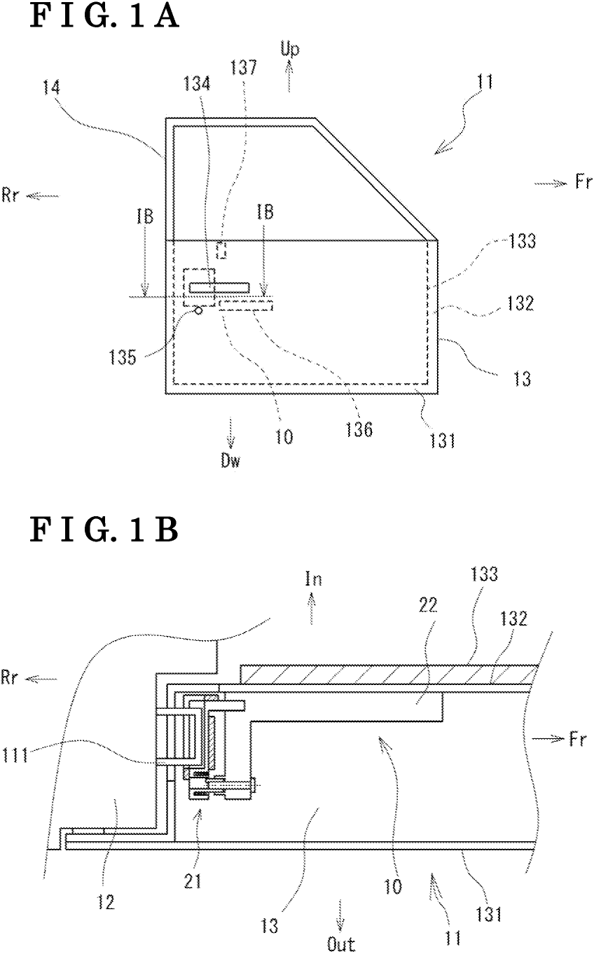

FIG. 1A is a side view of a vehicle door 11 to which a door lock apparatus 10 is applied, and is a view seen from a vehicle outer side. FIG. 1B is a cross-sectional view of the vicinity of a rear end portion of the vehicle door 11 to which the door lock apparatus 10 is applied, and is a cross-sectional view taken along line IB-IB in FIG. 1A.

The vehicle door 11 is attached to a vehicle body 12 in an openable and closable manner. Specifically, a front end portion of the vehicle door 11 is rotatably coupled to the vehicle body 12, and the vehicle door 11 is movable between a closed position and an opened position when being rotated with respect to the vehicle body 12. The closed position is a position where the vehicle door 11 closes an opening portion for getting in and out provided in the vehicle body 12, and the opened position is a position where the opening portion is not closed. The vehicle door 11 includes a door body portion 13 constituting a lower half portion of the vehicle door 11 and a door sash 14 provided on an upper half portion of the vehicle door 11. The door body portion 13 includes an outer panel 131, an inner panel 132, and a trim 133. The outer panel 131 constitutes an outer side surface of the vehicle door 11. The inner panel 132 is located on a vehicle inner side of the outer panel 131 and is fixed to the outer panel 131. The trim 133 is fixed to a vehicle inner side of the inner panel 132 and constitutes an inner side surface of the door body portion 13.

An outside door handle 134 and a key cylinder 135 are attached in the vicinity of a rear end portion of the outer panel 131. The outside door handle 134 is an operation member that can be manually operated by a user of the vehicle and is movable between an initial position and an operation position when being rotated with respect to the vehicle door 11. The outside door handle 134 is elastically biased toward the initial position by a biasing member (not shown) and is held at the initial position by a biasing force of the biasing member in a state in which the outside door handle 134 is not operated by the user (a state in which no external force is applied).

The key cylinder 135 includes an inner cylinder (also referred to as a plug). The inner cylinder is configured to allow a suitable key to be inserted therein and removed therefrom in a state in which the inner cylinder is located at a neutral position, and is rotationally movable from the neutral position to an unlock position or a lock position in a state in which the suitable key is inserted. The unlock position is a position that the inner cylinder reaches when being rotated by a predetermined angle in a predetermined direction from the neutral position, and the lock position is a position that the inner cylinder reaches when being rotated by a predetermined angle in a direction opposite to the predetermined direction from the neutral position. In the following description, a manual operation of rotating the inner cylinder from the neutral position to the unlock position by rotating the inserted key is referred to as an “unlock operation”, and a manual operation of rotating the inner cylinder from the neutral position to the lock position is referred to as a “lock operation”. The inner cylinder is always elastically biased toward the neutral position by the biasing member and is held at the neutral position in a state in which the unlock operation and the lock operation are not performed (a state in which no external force is applied).

An inside door handle 136 and a lock knob 137 are attached to the inner panel 132. The inside door handle 136 is an operation member that can be manually operated by the user of the vehicle and is rotationally movable between an initial position and an operation position when being rotated with respect to the vehicle door 11. The inside door handle 136 is elastically biased toward the initial position by a biasing member (not shown) and is held at the initial position in a state in which the inside door handle 136 is not operated by the user (a state in which no external force is applied).

The lock knob 137 is an operation member that can be manually operated by the user. The lock knob 137 is located, for example, in the vicinity of an upper end of the trim 133 or the vicinity of the inside door handle 136, and is movable between a lock position and an unlock position, for example, when being moved in the upper-lower direction with respect to the vehicle door 11 or when being rotated with respect to the vehicle door 11.

### Door Lock Apparatus

As shown in FIG. 1B, the door lock apparatus 10 is disposed in an internal space of the vehicle door 11 (that is, a space surrounded by the outer panel 131 and the inner panel 132). The door lock apparatus 10 is fixed to the inner panel 132 (that is, the vehicle door 11). A part of the door lock apparatus 10 is exposed to the outside of the vehicle door 11 from the rear end portion of the vehicle door 11.

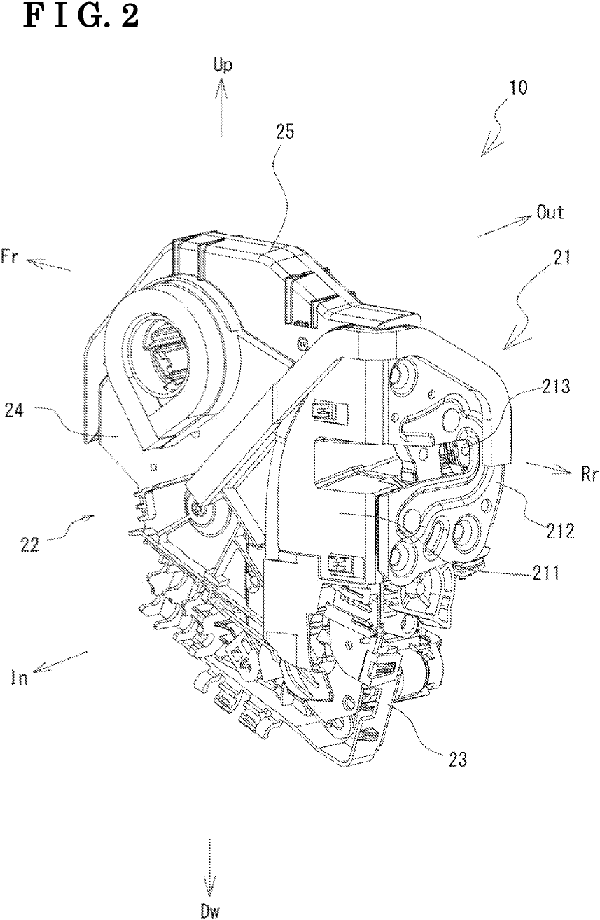

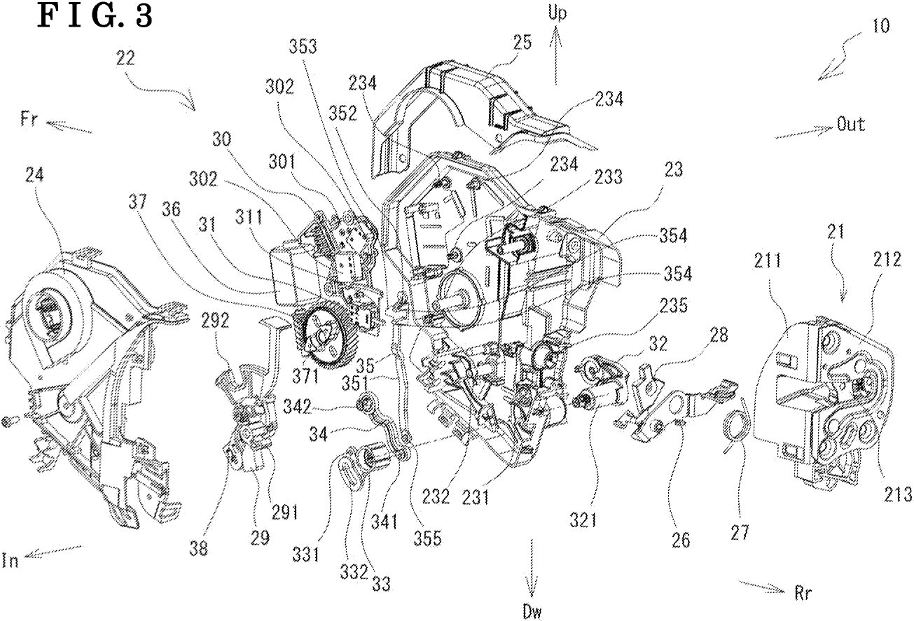

FIG. 2 is a perspective view of an appearance of the door lock apparatus 10, and FIG. 3 is an exploded perspective view of the door lock apparatus 10. As shown in FIGS. 2 and 3, the door lock apparatus 10 includes a mesh body 21 and an actuator body 22.

The mesh body 21 includes a base member 211, a base plate 212, a sub-plate (not shown), a latch 213, a pawl (not shown), a lift lever (not shown), a latch return spring (not shown), and a pawl return spring (not shown). The base member 211, the base plate 212, and the sub-plate form a casing of the mesh body 21. The latch 213, the pawl, the lift lever, the latch return spring, and the pawl return spring constitute a latch mechanism. The latch mechanism is switchable between an unlatched state and a latched state. The unlatched state is a state in which the vehicle door 11 is allowed to move from the closed position to the opened position. The latched state is a state in which movement of the vehicle door 11 from the closed position to the opened position is not allowed (movement is restricted). In the present embodiment, the latch mechanism is configured to be held in the latched state when the lift lever is located at a latch engagement position, and to be switched from the latched state to the unlatched state when the lift lever moves from the latch engagement position to a latch disengagement position in the latched state.

The actuator body 22 includes a housing 23, a cover 24, a waterproof cover 25, an open lever 26, an open lever return spring 27, an open link 28, an active lever 29, a terminal sub-assembly 30, an external key lever 32, an internal key lever 33, an active lever link 34, a key switch link 35, an actuator 36, and a wheel gear 37. The terminal sub-assembly 30 includes a key switch 31 and a support board 301.

The actuator body 22 is configured such that the latch mechanism in the latched state can be switched to the unlatched state by an operation performed by the user of the vehicle or the like on at least one of the outside door handle 134 and the inside door handle 136 (movement from the initial position to the operation position).

The housing 23 and the cover 24 are members that form a casing of the actuator body 22. The housing 23 and the cover 24 are each made of a resin material. A key lever support hole 231, an active lever support shaft 232, a wheel gear support shaft 233, and support bosses 234 are provided on an inner peripheral surface (a surface on an inner side in the vehicle width direction in the embodiment) of the housing 23. The key lever support hole 231 is a hole into which the external key lever 32 is rotatably inserted, and is a round hole penetrating the housing 23 in the vehicle width direction. The active lever support shaft 232 is a shaft for rotatably supporting the active lever 29 and is a cylindrical shaft protruding inward in the vehicle width direction. The wheel gear support shaft 233 is a shaft for rotatably supporting the wheel gear 37 and is a cylindrical shaft protruding inward in the vehicle width direction. The plurality of support bosses 234 are bosses for supporting the terminal sub-assembly 30 and are columnar bosses protruding inward in the vehicle width direction. The key lever support hole 231 is provided in the vicinity of a lower end portion of the housing 23, whereas the plurality of support bosses 234 are provided in the vicinity of an upper end portion of the housing 23 (at least above the key lever support hole 231). An open lever support shaft 235 is a shaft for rotatably supporting the open lever 26 and is a cylindrical shaft provided on a rear outer surface of the housing 23 and protruding rearward (toward the outside of the housing 23).

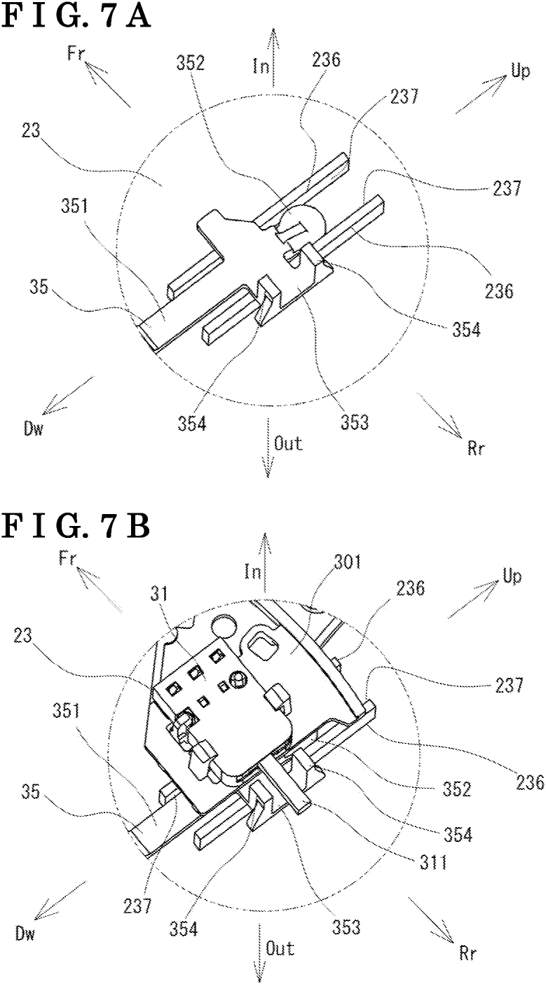

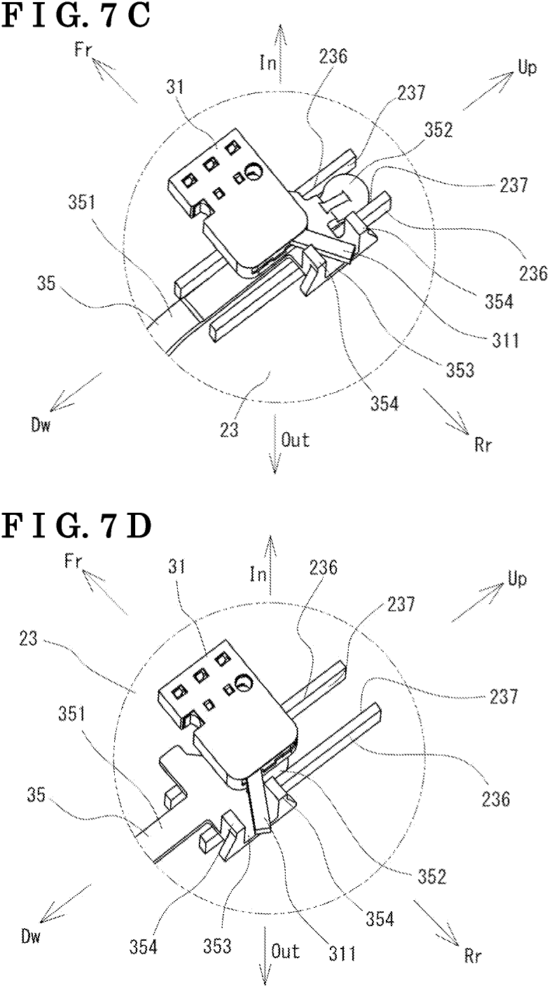

Further, two guide portions 236 for guiding a sliding portion 352 of the key switch link 35 to be described later are provided on the inner peripheral surface of the housing 23 (see FIGS. 7A to 7D). The two guide portions 236 are protruding portions that extend substantially in the upper-lower direction and are spaced apart from each other by a predetermined distance in the front-rear direction. Guide surfaces 237 of the two guide portions 236 that are surfaces facing each other are an example of two guide surfaces disclosed here.

The waterproof cover 25 is a member for preventing water or the like (for example, rainwater) from entering inside the housing 23 and the cover 24 from above. The waterproof cover 25 is attached to cover upper portions of the housing 23 and the cover 24.

The open lever 26 is rotatably supported with respect to the housing 23 via the open lever support shaft 235 and is movable between an initial position and an operation position when being rotated. The open lever 26 is coupled to the outside door handle 134 via a rod, a wire, or the like. The open lever 26 is configured to move from the initial position to the operation position when the outside door handle 134 moves from the initial position to the operation position. In addition, the open lever 26 is also configured to move from the initial position to the operation position in conjunction with movement of the inside door handle 136 when the inside door handle 136 is operated (moved from the initial position to the operation position). The open lever 26 is always elastically biased toward the initial position by the open lever return spring 27 and is held at the initial position when no external force other than a biasing force of the open lever return spring 27 is applied (that is, when the outside door handle 134 and the inside door handle 136 are not operated).

The open link 28 is rotatably supported with respect to the open lever 26 and is movable between an unlock position and a lock position when being rotated with respect to the open lever 26. In addition, the open link 28 is configured to move together with movement of the open lever 26 to the initial position and the operation position in a state in which the open link 28 is located at the unlock position and the lock position.

The unlock position of the open link 28 is a position where the open link 28 abuts against the lift lever to push the lift lever and move the lift lever (and the pawl) from the latch engagement position to the latch disengagement position when the open link 28 moves together with the movement of the open lever 26 from the initial position to the operation position. The lock position of the open link 28 is a position where the open link 28 does not abut against the lift lever when the open link 28 moves together with the movement of the open lever 26 from the initial position to the operation position. In a case where the open link 28 is located at the lock position, the lift lever (and the pawl) does not move from the latch engagement position to the latch disengagement position (is held at the latch engagement position) even when the open lever 26 and the open link 28 move from the initial position to the operation position. The open link 28 is always elastically biased toward the unlock position by an open link biasing spring.

A state in which the open link 28 is located at the unlock position is an unlocked state of the door lock apparatus 10, and a state in which the open link 28 is located at the lock position is a locked state of the door lock apparatus 10. As described above, when the outside door handle 134 or the inside door handle 136 is operated (move from the initial position to the operation position), the open lever 26 moves from the initial position to the operation position. At this time, when the door lock apparatus 10 is in the unlocked state, the open link 28 moves together with the movement of the open lever 26 from the initial position to the operation position in a state in which the open link 28 is located at the unlock position. The open link 28 engages with the lift lever to push the lift lever, and the lift lever moves from the latch engagement position to the latch disengagement position. Therefore, the latch mechanism is switched from the latched state to the unlatched state, and the movement of the vehicle door 11 from the closed position to the opened position is allowed. On the other hand, when the door lock apparatus 10 is in the locked state, the open link 28 moves together with the movement of the open lever 26 from the initial position to the operation position in a state in which the open link 28 is located at the lock position. In this case, since the open link 28 does not engage with the lift lever, the lift lever does not move from the latch engagement position. Therefore, the latch mechanism is not switched from the latched state to the unlatched state. Therefore, the latch mechanism is not switched from the latched state to the unlatched state, and the movement of the vehicle door 11 from the closed position to the opened position is not allowed.

In this way, the unlocked state of the door lock apparatus 10 is a state in which the latch mechanism in the latched state is switched to the unlatched state (in other words, a state in which the latch mechanism is allowed to switch from the latched state to the unlatched state) when at least one of the outside door handle 134 and the inside door handle 136 is operated. The locked state is a state in which the latch mechanism in the latched state is not switched to the unlatched state (in other words, a state in which the latch mechanism is not allowed to switch from the latched state to the unlatched state) even when the outside door handle 134 and the inside door handle 136 are operated.

The active lever 29, the external key lever 32, the internal key lever 33, and the active lever link 34 are configured to allow the door lock apparatus 10 to be switched between the unlocked state and the locked state by an operation performed on the key cylinder 135 by a user or the like. The key switch link 35 and the key switch 31 can detect the unlock operation and the lock operation performed on the key cylinder 135.

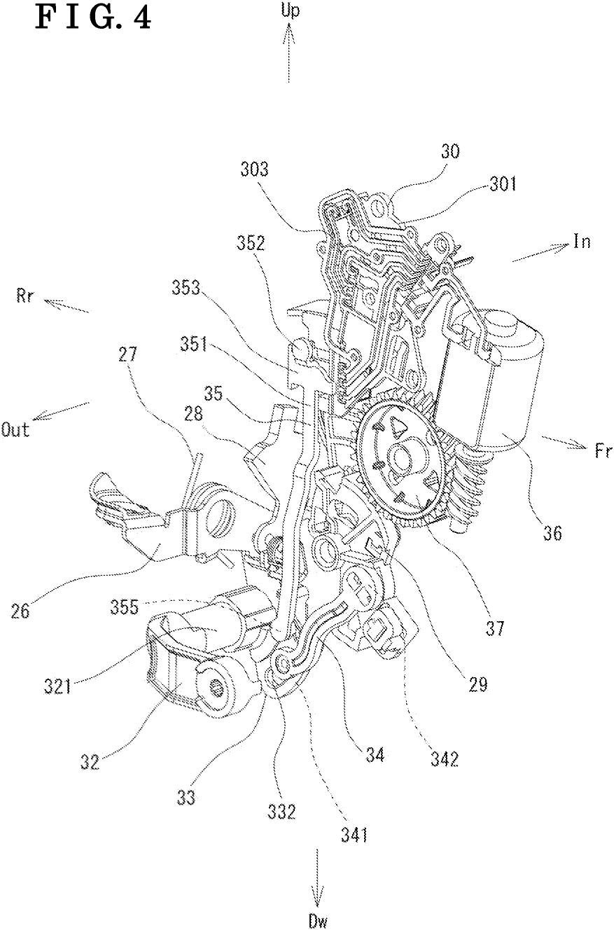

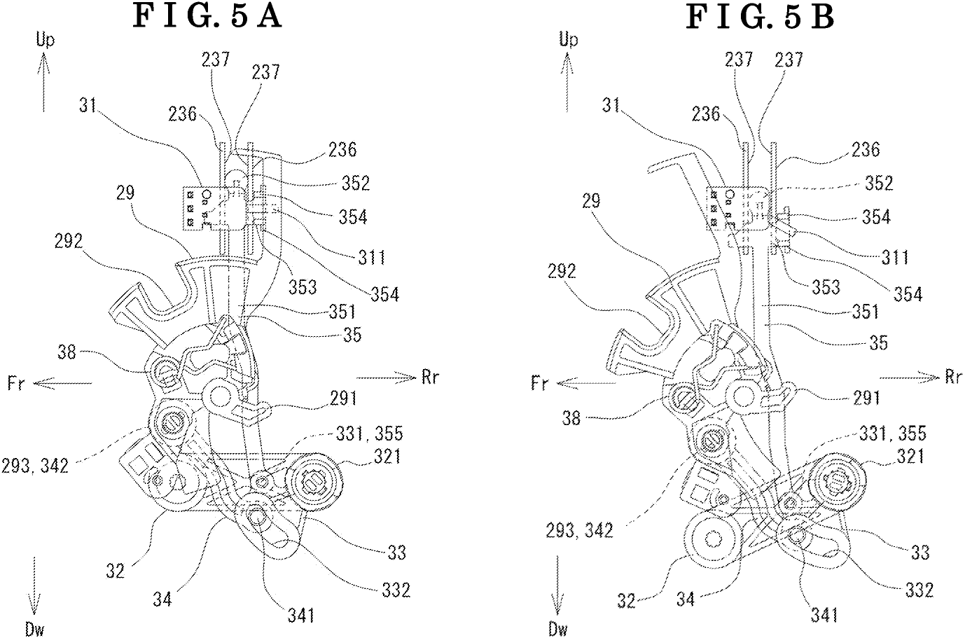

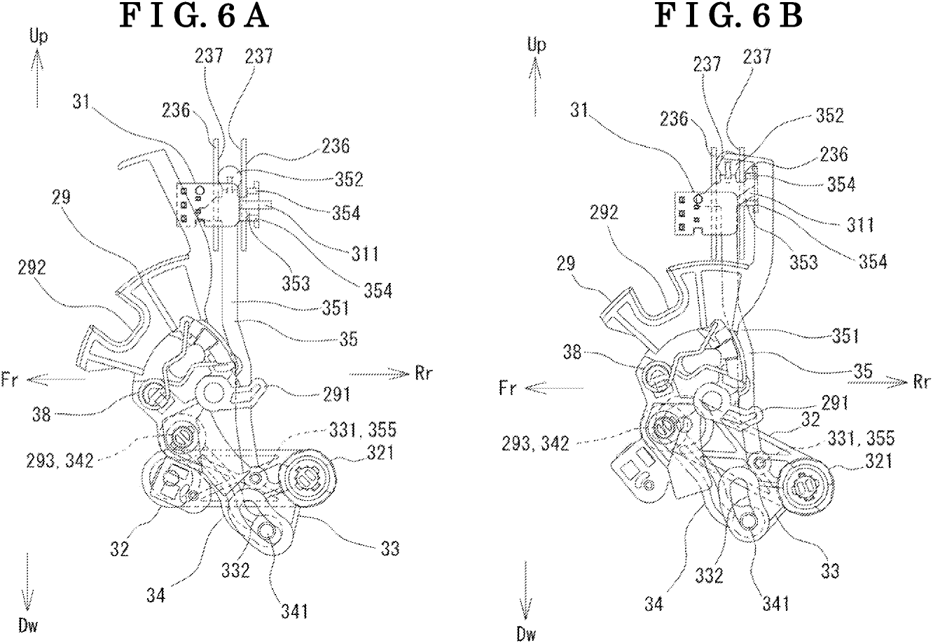

Here, configurations and operations of the active lever 29, the external key lever 32, the internal key lever 33, the active lever link 34, the key switch link 35, and the key switch 31 will be described with reference to FIGS. 4 and 5A to 6B. FIG. 4 is a perspective view showing a configuration of members disposed inside the casing of the actuator body 22. FIGS. 5A to 6B are views showing a configuration and operations of the active lever 29, the external key lever 32, the internal key lever 33, the active lever link 34, the key switch link 35, and the key switch 31. FIG. 5A is a view showing a state in which the door lock apparatus 10 is in the unlocked state and the inner cylinder of the key cylinder 135 is located at the neutral position. FIG. 5B is a view showing a state in which the inner cylinder of the key cylinder 135 is moved to the lock position (the lock operation is performed) from the state shown in FIG. 5A. FIG. 6A is a view showing a state in which the door lock apparatus 10 is in the locked state and the inner cylinder of the key cylinder 135 is located at the neutral position. FIG. 6B is a view showing a state in which the inner cylinder of the key cylinder 135 is moved to the unlock position (the unlock operation is performed) from the state shown in FIG. 6A.

The active lever 29 is an example of a first member disclosed here. The active lever 29 is provided with a first engagement portion 291, a second engagement portion 292, and a coupling hole 293. The first engagement portion 291 is a protruding portion protruding rearward and is configured to be freely engaged with and disengaged from the open link 28. The second engagement portion 292 is a recess portion (a notched portion) opened upward, and is configured to be freely engaged with and disengaged from (freely inserted to and removed from) an engagement portion 371 provided on the wheel gear 37 to be described later. The coupling hole 293 is a hole for rotatably coupling the active lever link 34 and is a round hole penetrating the active lever 29 in the vehicle width direction.

The active lever 29 is rotatably (swingably) attached to the housing 23 via the active lever support shaft 232 and can be moved to a lock position (see FIGS. 5B and 6A) and an unlock position (see FIGS. 5A and 6B) when being rotated with respect to the housing 23. The lock position of the active lever 29 is an example of a first position of the first member disclosed here, and the unlock position is an example of a second position of the first member disclosed here. The lock position is a position on one end in a rotatable range with respect to the housing 23, and the unlock position is a position on an end on a side opposite to the lock position. In FIGS. 5A to 6B, the lock position of the active lever 29 is a position that the active lever 29 reaches when being rotated in a counterclockwise direction by a predetermined angle from the unlock position. The active lever 29 is elastically biased toward the lock position by a detent spring 38 when the active lever 29 is located on a side closer to the lock position than a turn over point that is an intermediate position between the lock position and the unlock position, and is elastically biased toward the unlock position when the active lever 29 is located on a side closer to the unlock position than the turn over point. Therefore, in a state in which no external force other than that of the detent spring 38 is applied, the active lever 29 is held at either the lock position or the unlock position.

When the active lever 29 is held at the lock position by a biasing force of the detent spring 38, the open link 28 is held in a state of being pushed by the first engagement portion 291 of the active lever 29 and thus is held at the lock position. When the active lever 29 moves from the lock position to the unlock position, the open link 28 is moved from the lock position to the unlock position by a biasing force of the open link biasing spring. In this way, when the active lever 29 is located at the unlock position, the door lock apparatus 10 is held in the unlocked state, and when the active lever 29 is located at the lock position, the door lock apparatus 10 is held in the locked state. The door lock apparatus 10 can be switched between the unlocked state and the locked state by moving the active lever 29 between the unlock position and the lock position.

The internal key lever 33 is an example of a second member disclosed here. It can also be said that the external key lever 32 and the internal key lever 33 are an example of the second member disclosed here. The external key lever 32 and the internal key lever 33 are coupled to each other, rotatably supported with respect to the housing 23, and integrally rotatable with respect to the housing 23. Specifically, the external key lever 32 includes a substantially columnar shaft portion 321, and the shaft portion 321 is rotatably supported with respect to the housing 23 by being inserted into the key lever support hole 231 from the outside of the housing 23. The internal key lever 33 is coupled to a tip end portion of the shaft portion 321 of the external key lever 32 (an end portion located on an inner peripheral side of the housing 23) to rotate integrally with the external key lever 32.

The external key lever 32 and the internal key lever 33 are movable to a neutral position, an unlock position and a lock position when being rotated. The neutral position of the internal key lever 33 (and the internal key lever 33) is an example of a third position of the second member disclosed here, the unlock position is an example of a fourth position of the second member disclosed here, and the lock position is an example of a fifth position of the second member disclosed here. The neutral position of the external key lever 32 and the internal key lever 33 is an intermediate (substantially central) position in a rotatable range with respect to the housing 23 (see FIGS. 5A and 6A). The unlock position of the external key lever 32 and the internal key lever 33 is a position that the external key lever 32 and the internal key lever 33 reach when being rotated in a predetermined direction (a clockwise direction in FIGS. 5A to 6B) by a predetermined angle from the neutral position (see FIG. 6B). The lock position of the external key lever 32 and the internal key lever 33 is a position that the external key lever 32 and the internal key lever 33 reach when being rotated in a direction opposite to the predetermined direction (a counterclockwise direction in FIGS. 5A to 6B) by a predetermined angle from the neutral position (see FIG. 5B). More specifically, the unlock position of the external key lever 32 and the internal key lever 33 is a position where a portion in front of a rotation center thereof (a portion on a side where a first coupling hole 331 and a second coupling hole 332 to be described later are provided in the front-rear direction) is higher than the neutral position. In addition, the lock position of the external key lever 32 and the internal key lever 33 is a position where the portion in front of the rotation center is lower than the neutral position.

The external key lever 32 is coupled to the inner cylinder of the key cylinder 135 outside the housing 23 and the cover 24. When the key cylinder 135 is located at the neutral position, the external key lever 32 and the internal key lever 33 are also located at the neutral position, when the inner cylinder of the key cylinder 135 is moved to the unlock position, the external key lever 32 and the internal key lever 33 are also moved to the unlock position, and when the inner cylinder of the key cylinder 135 is moved to the lock position, the external key lever 32 and the internal key lever 33 are also moved to the lock position.

The internal key lever 33 is provided with the first coupling hole 331 and the second coupling hole 332. The first coupling hole 331 is a hole for coupling the key switch link 35 and is a round hole penetrating the internal key lever 33 in the vehicle width direction. The second coupling hole 332 is a hole for coupling the active lever link 34 and is an arc-shaped long hole penetrating the internal key lever 33 in the vehicle width direction and centered on the rotation center of the internal key lever 33. The first coupling hole 331 and the second coupling hole 332 are located higher when the internal key lever 33 is located at the unlock position than when the internal key lever 33 is located at the neutral position, and are located lower when the internal key lever 33 is located at the lock position than when the internal key lever 33 is located at the neutral position. With respect to an extension direction of the second coupling hole 332 (a circumferential direction of a circle centered on the rotation center of the internal key lever 33), a front side in a movement direction when the internal key lever 33 moves from the neutral position to the unlock position is referred to as an “unlock side”, and a front side in a movement direction when the internal key lever 33 moves from the neutral position to the lock position is referred to as a “lock side”. In the embodiment, the upper side is the unlock side and the lower side is the lock side.

The active lever link 34 has a long rod shape. A first coupling boss 341 and a second coupling boss 342 each having a circular column shape (or a circular plate shape) protruding inward in the vehicle width direction are provided on both end portions of the active lever link 34 in a longitudinal direction thereof. The first coupling boss 341 is inserted into the second coupling hole 332 of the internal key lever 33, and the second coupling boss 342 is inserted into the coupling hole 293 provided in the active lever 29 (see FIG. 4). In this way, the internal key lever 33 and the active lever 29 are coupled by the active lever link 34. The second coupling boss 342 is rotatable with respect to the active lever 29 and is not movable in the front-rear direction and the upper-lower direction with respect to the active lever 29. In addition, since the second coupling hole 332 of the internal key lever 33 is an arc-shaped long hole, the first coupling boss 341 is rotatable with respect to the internal key lever 33 and is movable inside the second coupling hole 332 in the extension direction thereof.

As shown in FIG. 5A, when the active lever 29 is located at the unlock position whereas the external key lever 32 and the internal key lever 33 are located at the neutral position, the first coupling boss 341 is located in the vicinity of an unlock side end portion of the second coupling hole 332. In this state, when the inner cylinder of the key cylinder 135 moves from the neutral position to the lock position, an inner peripheral surface of the unlock side end portion of the second coupling hole 332 of the internal key lever 33 comes into contact with the first coupling boss 341 and pushes down the first coupling boss 341. Therefore, the active lever link 34 is pulled downward by the internal key lever 33, and as a result, the active lever 29 rotates in the counterclockwise direction in the drawing and moves from the unlock position to the lock position. Thereafter, when the external key lever 32 and the internal key lever 33 return to the neutral position, the door lock apparatus 10 enters the state shown in FIG. 6A.

As shown in FIG. 6A, when the active lever 29 is located at the lock position whereas the external key lever 32 and the internal key lever 33 are located at the neutral position, the first coupling boss 341 is located in the vicinity of a lock side end portion of the second coupling hole 332. In this state, when the inner cylinder of the key cylinder 135 moves from the neutral position to the unlock position, an inner peripheral surface of the lock side end portion of the second coupling hole 332 comes into contact with the first coupling boss 341 and pushes up the first coupling boss 341. Therefore, the active lever link 34 is pushed up by the internal key lever 33, and as a result, the active lever 29 rotates in the clockwise direction in the drawing and moves from the lock position to the unlock position. Thereafter, when the external key lever 32 and the internal key lever 33 return to the neutral position, the door lock apparatus 10 enters the state shown in FIG. 5A.

In this way, the door lock apparatus 10 is switchable between the unlocked state and the locked state by the unlock operation and the lock operation performed on the key cylinder 135.

The actuator 36 is a rotational power source of the wheel gear 37. An electric motor capable of outputting rotational power in both forward and reverse directions can be applied as the actuator 36. The actuator 36 is controlled by a control device (not shown) of the door lock apparatus 10 to output rotational power. A worm is attached to an output shaft of the actuator 36. The wheel gear 37 is rotatably supported with respect to the housing 23 via the wheel gear support shaft 233. The wheel gear 37 meshes with the worm of the actuator 36, and is rotatable in both forward and reverse directions by the rotational power output from the actuator 36. The wheel gear 37 is provided with the engagement portion 371. The engagement portion 371 of the wheel gear 37 has a protruding configuration that protrudes in a rotation center line direction (inward in the vehicle width direction) of the wheel gear 37 and is freely inserted into and removed from the second engagement portion 292 of the active lever 29. When the wheel gear 37 is rotated in a predetermined direction by a driving force of the actuator 36, the engagement portion 371 of the wheel gear 37 pushes an inner peripheral surface of the second engagement portion 292 of the active lever 29 and moves the active lever 29 from the lock position to the unlock position. On the other hand, when the wheel gear 37 is rotated in a direction opposite to the predetermined direction by the driving force of the actuator 36, the engagement portion 371 of the wheel gear 37 pushes the inner peripheral surface of the second engagement portion 292 of the active lever 29 and moves the active lever 29 from the unlock position to the lock position.

The active lever 29 is coupled to the lock knob 137 provided on the vehicle door 11 by a coupling member such as a wire (not shown). When the lock knob 137 is manually operated to move from the unlock position to the lock position, the movement is transmitted to the active lever 29 via the coupling member, and the active lever 29 is moved from the unlock position to the lock position. Similarly, when the lock knob 137 is manually operated to move from the lock position to the unlock position, the movement is transmitted to the active lever 29 via the coupling member, and the active lever 29 is moved from the lock position to the unlock position.

In this way, the vehicle door lock apparatus 10 is switchable between the locked state and the unlocked state by the driving force of the actuator 36 and the manual operation of the lock knob 137 provided on the vehicle door 11.

The terminal sub-assembly 30 includes the key switch 31 and the support board 301 on which the key switch 31 is mounted. Members other than the key switch 31 may also be mounted on the support board 301. For example, another switch 302 such as a switch for detecting the position of the active lever 29 and a wiring fitting 303 for electrically connecting the key switch 31 and the other switch 302 to the outside of the terminal sub-assembly 30 may be mounted on the support board 301.

The key switch 31 is an electrical switch for detecting the operation of the key cylinder 135. The key switch 31 includes a lever 311 that can swing in a pendulum manner and is configured to switch between OFF and ON (switch between an OFF state and an ON state) according to a position of the lever 311. Specifically, the key switch 31 is configured such that the key switch 31 is in a first state (for example, the OFF state) when the lever 311 is located at a center of a swingable range and in the vicinity thereof, is in a second state (for example, the ON state) when the lever 311 is located at one end of the swingable range and in the vicinity thereof, and is in a third state (for example, an ON state different from the second state) when the lever 311 is located at the other end portion of the swingable range and in the vicinity thereof. The key switch 31 is connected to the control device (not shown) of the door lock apparatus 10. The control device (not shown) of the door lock apparatus 10 can detect the state of the key switch 31. In addition, the lever 311 is always elastically biased toward the position of the first state, and the key switch 31 is held in the first state in a state in which no external force is applied to the lever 311. The support board 301 is a flat plate-shaped member that is electrically insulating. For example, the support board 301 is made of a resin material. A specific configuration of the support board 301 is not particularly limited. The terminal sub-assembly 30 is attached to the housing 23 via the support bosses 234 provided on the housing 23.

The key switch link 35 is an example of a third member disclosed here. The key switch link 35 is a long rod-shaped member for switching the state of the key switch 31. The key switch link 35 is made of, for example, a resin material and is manufactured by injection molding. The key switch link 35 is disposed such that a longitudinal direction thereof is substantially parallel to the upper-lower direction. The key switch link 35 includes a body portion 351, the sliding portion 352 provided on an upper end portion of the body portion 351, a support portion 353 provided in the vicinity of the upper end portion of the body portion 351 and below the sliding portion 352, a switch operation lever 354 provided on the support portion 353, and a coupling boss 355 provided on a lower end portion of the body portion 351.

The body portion 351 is a plate-shaped portion having a width dimension (a dimension in the front-rear direction) larger than a thickness dimension (a dimension in the vehicle width direction). The coupling boss 355 is a cylindrical (or columnar) portion that protrudes inward in the vehicle width direction from the lower end portion of the body portion 351, and is inserted into the first coupling hole 331 of the internal key lever 33 from an outer side in the vehicle width direction. Therefore, the key switch link 35 is rotatable about a lower end portion thereof with respect to the internal key lever 33. Since the first coupling hole 331 of the internal key lever 33 is a round hole, the key switch link 35 is rotatable (swingable in a pendulum manner) about the first coupling hole 331 (the coupling boss 355) with respect to the internal key lever 33, whereas the coupling boss 355 of the key switch link 35 cannot move in the upper-lower direction and the front-rear direction with respect to the internal key lever 33.

Here, a configuration and operations of the sliding portion 352 and the support portion 353 of the key switch link 35 will be described with reference to FIGS. 7A to 7D. FIG. 7A is a view showing a positional relationship between the guide portions 236 and a configuration of an upper end portion of the key switch link 35 and the vicinity thereof. FIG. 7B is a view showing a positional relationship between the key switch 31 and the configuration of the upper end portion of the key switch link 35 and the vicinity thereof. FIGS. 7C and 7D are views showing operations of the key switch link 35 and the key switch 31.

As shown in FIG. 7A, the sliding portion 352 is a plate-shaped portion having a substantially circular shape when viewed in the vehicle width direction. In addition, the sliding portion 352 protrudes outward in the vehicle width direction beyond vehicle width direction outer side surfaces of the body portion 351 and the support portion 353 of the key switch link 35 (see also FIG. 4). The sliding portion 352 is inserted between the two guide portions 236 and is movable in an extension direction of the two guide portions 236 (the upper-lower direction in the embodiment) in a state of being inserted. For example, an outer diameter of the sliding portion 352 has a dimension substantially equal to or slightly smaller than a distance between facing surfaces (the two guide surfaces 237 disclosed here) of the two guide portions 236.

The support portion 353 is a flat plate-shaped portion extending in the front-rear direction from the body portion 351. A dimension of the support portion 353 in the front-rear direction is larger than a distance between the two guide portions 236. The support portion 353 is located inward in the vehicle width direction than tip end portions (an end portion on the inner side in the vehicle width direction) in a protrusion direction of the two guide portions 236, and does not enter between the two guide portions 236. In addition, the support portion 353 overlaps the guide portions 236 as viewed in the vehicle width direction. Therefore, the support portion 353 and the body portion 351 of the key switch link 35 can swing in a pendulum manner about the sliding portion 352 without interfering with the two guide portions 236.

Two switch operation levers 354 protruding inward in the vehicle width direction are spaced apart from each other in the upper-lower direction in the vicinity of a rear side of the support portion 353 on portions located on outer sides of the two guide portions 236 when viewed in the vehicle width direction. The two switch operation levers 354 are configured such that the lever 311 of the key switch 31 can be freely inserted therebetween.

As shown in FIG. 7B, the terminal sub-assembly 30 is disposed on an inner side of the two guide portions 236 and the key switch link 35 in the vehicle width direction. As shown in FIG. 7B, when viewed in the vehicle width direction, the lever 311 of the key switch 31 protrudes rearward from the support board 301 and is located between the two switch operation levers 354 of the key switch link 35. For example, the key switch 31 is disposed in such a direction that the key switch 31 is switched from the first state to the second state when the lever 311 is lifted and is switched from the first state to the third state when the lever 311 is lowered.

In this way, the support portion 353 of the key switch link 35 is interposed between the two guide portions 236 and the support board 301. Therefore, since movement of the key switch link 35 in the vehicle width direction is restricted by the support board 301, the sliding portion 352 is prevented from coming out of the two guide portions 236.

As shown in FIG. 7C, when the external key lever 32 and the internal key lever 33 are moved from the neutral position to the unlock position, the key switch link 35 is lifted, and the lower one of the two switch operation levers 354 pushes up the lever 311 of the key switch 31. Therefore, the key switch 31 is switched from the first state to the second state. In addition, as shown in FIG. 7D, when the external key lever 32 and the internal key lever 33 are moved from the neutral position to the lock position, the key switch link 35 is lowered, and the upper one of the two switch operation levers 354 pushes down the lever 311 of the key switch 31. Therefore, the key switch 31 is switched from the first state to the third state. In this way, the operation of the key cylinder 135 (rotation from the neutral position to the unlock position and rotation from the neutral position to the lock position) can be detected by the key switch 31 and the key switch link 35.

As in the embodiment, when the lower end portion of the key switch link 35 is rotatably coupled to the internal key lever 33 in a manner not allowing parallel movement, a movement locus of the lower end portion of the key switch link 35 along with rotation of the internal key lever 33 is an arc centered on the rotation center of the internal key lever 33. On the other hand, since the sliding portion 352 on the upper end portion of the key switch link 35 is inserted between the two guide portions 236 (located between the two guide surfaces 237), the sliding portion 352 can move in the extension direction of the two guide portions 236 and cannot move in a direction perpendicular to the extension direction of the two guide portions 236 (however, the sliding portion 352 can move by a clearance). Therefore, when the key switch link 35 moves in the upper-lower direction along with the rotation of the internal key lever 33, the key switch link 35 swings in a pendulum manner about the sliding portion 352 on the upper end portion. In other words, an angle between the longitudinal direction of the key switch link 35 and the extension direction of the two guide portions 236 changes.

However, the sliding portion 352 is substantially circular as viewed in the vehicle width direction (at least, a guide-contacting portion of an outer periphery of the sliding portion 352 is substantially circular). Therefore, even when the angle between the longitudinal direction of the key switch link 35 and the extension direction of the two guide portions 236 changes, a contact state between the outer periphery of the sliding portion 352 and the two guide portions 236 does not change. Therefore, even when the key switch link 35 swings as described above, smooth movement of the key switch link 35 in the upper-lower direction with respect to the two guide portions 236 is not hindered.

The coupling boss 355 on the lower end portion of the key switch link 35 is rotatably inserted into the first coupling hole 331 of the internal key lever 33 in a manner not allowing movement in parallel. The coupling boss 355 of the key switch link 35 is held in contact with an inner peripheral surface of the first coupling hole 331 of the internal key lever 33. Therefore, even when the door lock apparatus 10 vibrates or the like, it is possible to prevent a contact sound (a striking sound or a collision sound) from being generated between the key switch link 35 and the internal key lever. Therefore, it is possible to prevent generation of a sound perceived as an abnormal sound by the user.

The support board 301 overlaps a portion of the key switch link 35 (more specifically, a portion where the two sliding portions 352 and the support portion 353 are provided and the vicinity thereof) and the two guide portions 236. Therefore, the sliding portion 352 of the key switch link 35 is prevented by the support board 301 from coming out from between the two guide portions 236. In addition, when the sliding portion 352 is held by the support board 301 so as not to come out, another member for preventing the sliding portion 352 from coming out may not be disposed. Therefore, an increase in the number of components and the number of assembling steps can be prevented.

When the support board 301 overlaps the portion of the key switch link 35, an increase in a dimension of the vehicle door lock apparatus 10 as viewed in the vehicle width direction can be prevented or restrained. That is, when the key switch link 35 does not overlap the key switch 31 in the vehicle width direction, it is necessary to dispose the key switch link 35 and the key switch 31 side by side in the front-rear direction or the upper-lower direction. As a result, a dimension of a space for disposing the key switch link 35 and key switch 31 is large in the front-rear direction or the upper-lower direction. Meanwhile, according to the embodiment, a space for disposing the key switch link 35 and the key switch 31 as viewed in the vehicle width direction can be reduced. Therefore, a size of the door lock apparatus 10 can be reduced (or an increase in the size can be prevented or restrained).

According to the door lock apparatus according to the embodiment, the following operation can be implemented by detecting the lock operation on the key cylinder 135. When the unlock operation is performed on the key cylinder 135 while the door lock apparatus 10 is in the locked state, the door lock apparatus 10 coupled to the key cylinder 135 on which the unlock operation is performed is switched from the locked state to the unlocked state. The control device of the door lock apparatus 10 can detect the unlock operation on the key cylinder 135 by acquiring the state of the key switch 31. Thereafter, when the unlock operation on the key cylinder 135 is detected again, the control device of the door lock apparatus 10 drives the actuator 36 of the door lock apparatus 10 other than the door lock apparatus 10 coupled to the key cylinder 135 on which the unlock operation is performed, and switches the other door lock apparatus 10 from the locked state to the unlocked state.

According to such an operation, since the other door lock apparatus 10 is held in the locked state in the first unlock operation, security can be improved.

In the embodiment, the key switch 31 is separated from the external key lever 32 and the internal key lever 33 in the upper-lower direction. With such a configuration, movement of the internal key lever 33 (that is, the unlock operation and the lock operation on the key cylinder 135) can be detected by the key switch link 35. Therefore, for example, for the sake of waterproofing, the terminal sub-assembly 30 is disposed on the upper end portion of the housing 23 and the cover 24 and in the vicinity thereof, whereas the external key lever 32 and the internal key lever 33 that are allowed to be wet as compared with the terminal sub-assembly 30 are disposed on the lower end portion of the housing 23 and the cover 24 and in the vicinity thereof, so that it is possible to ensure smooth movement of the key switch link 35 while preventing or restraining wetting of the terminal sub-assembly 30.

Movement of the inner cylinder of the key cylinder 135 due to the unlock operation and the lock operation is transmitted to the active lever 29 via the external key lever 32, the internal key lever 33, and the active lever link 34. Therefore, according to such a configuration, a degree of freedom in a relative position between the door lock apparatus 10 and the key cylinder 135 can be improved.

When the active lever 29 moves due to the driving force of the actuator 36 and the manual operation of the lock knob 137, the internal key lever 33 does not move. Therefore, the state of the key switch 31 does not change. Specifically, as shown in FIG. 5A, when the door lock apparatus 10 is in the unlocked state, the first coupling boss 341 and the inner peripheral surface of the lock side end portion of the second coupling hole 332 are separated by a predetermined distance. In this state, when the active lever 29 moves from the unlock position to the lock position shown in FIG. 6A, the active lever link 34 is pushed by the active lever 29, and the first coupling boss 341 of the active lever link 34 moves toward the lock side inside the second coupling hole 332. At this time, since the first coupling boss 341 is not in contact with the inner peripheral surface of the lock side end portion of the second coupling hole 332, the internal key lever 33 does not move from the neutral position. Therefore, the key switch 31 is held in the first state.

Similarly, when the active lever 29 moves from the unlock position in the state shown in FIG. 6A to the unlock position shown in FIG. 5A, the active lever link 34 is pulled by the active lever 29, and the first coupling boss 341 moves toward the unlock side inside the second coupling hole 332. At this time, since the first coupling boss 341 is not in contact with the inner peripheral surface of the unlock side end portion of the second coupling hole 332, the internal key lever 33 does not move from the neutral position. Therefore, the key switch 31 is held in the first state.

Here, a configuration example of the latch mechanism will be briefly described. As described above, the latch mechanism includes the latch 213, the pawl, the lift lever, the latch return spring, and the pawl return spring.

The latch 213 includes a full latch claw, a half latch claw, and a striker holding groove. The full latch claw and the half latch claw each have a plate-shaped configuration extending radially outward from a rotation center of the latch 213. The striker holding groove is a groove where a striker 111 provided on the vehicle body 12 can be inserted and removed, and is provided between the full latch claw and the half latch claw.

The latch 213 is rotatably supported with respect to a casing of the mesh body 21 and is movable between a latch position and an unlatch position when being rotated. The latch position of the latch 213 is a position where the striker 111 is held when the vehicle door 11 is located at the closed position (in other words, a position where engagement between the latch 213 and the striker 111 cannot be released). When the latch 213 is held at the latch position while the vehicle door 11 is located at the closed position, the movement of the vehicle door 11 from the closed position to the opened position is not allowed. The unlatch position of the latch 213 is a position where the striker 111 provided on the vehicle body 12 and the latch 213 are freely engaged and disengaged (a position where the striker 111 is freely inserted into and removed from the striker holding groove). When the latch 213 is moved from the unlatch position to the latch position while the vehicle door 11 is located at the closed position, the movement of the vehicle door 11 from the closed position to the opened position is allowed. The latch 213 is always elastically biased toward the unlatch position by the latch return spring.

The pawl and the lift lever are rotatably supported by a casing of the door lock apparatus 10. The pawl and the lift lever are engaged with each other and configured to rotate integrally. The pawl and the lift lever are movable between the latch engagement position and the latch disengagement position when being rotated. The latch engagement position of the pawl and the lift lever is a position where the pawl engages with the latch to hold the latch 213 at the latch position (a position where the latch 213 is restricted from moving from the latch position to the unlatch position). The latch disengagement position of the pawl and the lift lever is a position outside a rotational movement locus of the latch 213, and is a position where the latch 213 is allowed to move from the latch position to the unlatch position. The pawl and the lift lever are always elastically biased toward the latch engagement position by the pawl return spring.

When the pawl and the lift lever are located at the latch engagement position while the vehicle door 11 is located at the closed position and the latch 213 is located at the latch position, the pawl engages with the latch 213. Accordingly, the pawl holds the latch 213 at the latch position. Therefore, the vehicle door 11 is held at the closed position (in other words, movement to the opened position is restricted). This state of the latch mechanism is the latched state. When the pawl and the lift lever move from the latch engagement position to the latch disengagement position against the biasing force of the pawl return spring while the vehicle door 11 is located at the closed position and the latch mechanism is in the latched state, the pawl is located outside a movement locus of the full latch claw and the half latch claw of the latch 213. Then, the latch 213 is moved from the latch position to the unlatch position by a biasing force of the latch return spring, and the latch 213 enters a state in which the striker 111 is not held (a state allowing free engagement and disengagement). Therefore, the vehicle door 11 is allowed to move to the opened position. This state of the latch mechanism is the unlatched state.

When the vehicle door 11 is moved from the opened position toward the closed position while the latch mechanism is in the unlatched state, the latch 213 is pushed by the striker 111 and moved from the unlatch position toward the latch position. At this time, the latch 213 can move from the unlatch position to the latch position by pushing the pawl out of the rotation locus of the latch 213 (moving the pawl from the latch engagement position to the latch disengagement position). When the vehicle door 11 reaches the closed position, the latch 213 reaches the latch position, whereas the pawl and the lift lever are held at the latch engagement position by the biasing force of the pawl return spring. Therefore, the latch mechanism is switched from the unlatched state to the latched state.

In this way, the latch mechanism is configured to switch from the latched state to the unlatched state by integrally rotating the pawl and the lift lever from the latch engagement position to the latch disengagement position when the vehicle door 11 is located at the closed position. A specific configuration is not limited to the above configuration example as long as the latch mechanism is configured to switch from the latched state to the unlatched state by moving the lift lever from the latch engagement position to the latch disengagement position. Various known configurations can be applied to the latch mechanism.

Although the embodiment disclosed here is described above, what is disclosed here is not limited to the embodiment. What is disclosed here can be modified without departing from the gist disclosed here, and the modification is also included in the technical scope disclosed here.

According to an aspect of this disclosure, a door lock apparatus includes:
a latch mechanism configured to be switched between a latched state in which opening of a vehicle door provided on a vehicle is not allowed and an unlatched state in which opening of the vehicle door is allowed;
a casing including two guide surfaces facing each other, the two guide surfaces extending in a first direction and being spaced apart from each other in a second direction perpendicular to the first direction;
a first member supported to be rotatably movable between a first position and a second position with respect to the casing, the first member being configured to restrict switching of the latch mechanism from the latched state to the unlatched state when the first member is located at the first position, and being configured to allow switching of the latch mechanism from the latched state to the unlatched state when the first member is located at the second position;
a second member supported to be movable with respect to the casing and elastically biased toward a third position, the second member being configured to move the first member located at the second position to the first position when the second member is moved from the third position to a fourth position by a manual operation, and being configured to move the first member located at the first position to the second position when the second member is moved from the third position to a fifth position by a manual operation;
a key switch that is an electrical switch configured to detect that the second member is manually operated, the key switch being switchable between an ON state and an OFF state; and
a third member whose one end portion is rotatably coupled to the second member and whose other end portion is provided with a sliding portion that is movably guided in the first direction with respect to the casing by being inserted between the two guide surfaces in a manner of being movable in the first direction, the third member being configured to switch ON and OFF of the key switch by moving with respect to the casing in conjunction with movement of the second member from the third position to the fourth position and movement of the second member from the third position to the fifth position, and
the sliding portion of the third member has a substantially circular shape when viewed in a third direction perpendicular to the first direction and the second direction.

As disclosed in this disclosure, when the sliding portion of the third member (the member for detecting a switching operation between a locked state and an unlocked state performed by a user) is substantially circular, a contact state between the sliding portion and the two guide surfaces does not change even when the third member swings in a pendulum manner around the sliding portion. Therefore, even when the third member swings as described above, smooth movement of the third member in the first direction with respect to the casing is not hindered. In addition, according to this disclosure, since a lower end portion of the third member is rotatably coupled to the second member, even when vibration or the like is applied to the vehicle door lock apparatus, it is possible to prevent a contact sound (a striking sound or a collision sound) from being generated between the third member and the second member.

The key switch may be disposed on the third member to overlap the third member in the third direction.

When the third member does not overlap the key switch in the third direction, it is necessary to dispose the third member and the key switch side by side in the first direction or the second direction. As a result, a dimension in the first direction or a dimension in the second direction (a dimension viewed in the third direction) of a space for disposing the third member and the key switch is large. Meanwhile, according to the above configuration, the space for disposing the third member and the key switch can be reduced as viewed in the third direction. Therefore, it is possible to reduce a size of the vehicle door lock apparatus (or to prevent or restrain an increase in size).

The key switch may be fixed to a support member that is a member separated from the casing,
the support member may be disposed on the third member to overlap the third member in the third direction, and
the third member may be restricted by the support member from moving in the third direction.

According to such a configuration, the movement of the third member in the third direction can be restricted without adding any dedicated component for restricting the movement of the third member in the third direction. Therefore, it is possible to prevent or restrain an increase in the number of components.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock apparatus comprising:
a latch mechanism configured to be switched between a latched state in which opening of a vehicle door provided on a vehicle is not allowed and an unlatched state in which opening of the vehicle door is allowed;
a casing including two guide surfaces facing each other, the two guide surfaces extending in a first direction and being spaced apart from each other in a second direction perpendicular to the first direction;
a first member supported to be rotatably movable between a first position and a second position with respect to the casing, the first member being configured to restrict switching of the latch mechanism from the latched state to the unlatched state when the first member is located at the first position, and being configured to allow switching of the latch mechanism from the latched state to the unlatched state when the first member is located at the second position;
a second member supported to be movable with respect to the casing and elastically biased toward a third position, the second member being configured to move the first member located at the second position to the first position when the second member is moved from the third position to a fourth position by a manual operation, and being configured to move the first member located at the first position to the second position when the second member is moved from the third position to a fifth position by a manual operation;
a key switch that is an electrical switch configured to detect that the second member is manually operated, the key switch being switchable between an ON state and an OFF state; and
a third member whose one end portion is rotatably coupled to the second member and whose other end portion is provided with a sliding portion that is movably guided in the first direction with respect to the casing by being inserted between the two guide surfaces in a manner of being movable in the first direction, the third member being configured to switch ON and OFF of the key switch by moving with respect to the casing in conjunction with movement of the second member from the third position to the fourth position and movement of the second member from the third position to the fifth position, wherein
the sliding portion of the third member has a substantially circular shape when viewed in a third direction perpendicular to the first direction and the second direction.

2. The vehicle door lock apparatus according to claim 1, wherein
the key switch is disposed on the third member to overlap the third member in the third direction.

3. The vehicle door lock apparatus according to claim 2, wherein
the key switch is fixed to a support member that is a member separated from the casing,
the support member is disposed on the third member to overlap the third member in the third direction, and
the third member is restricted by the support member from moving in the third direction.
